(19) United States
(12) Patent Application Publication
(10) Pub. No.: US 2010/0082369 A1
(43) Pub. Date: Apr. 1, 2010

(54) Systems and Methods for Interconnected Personalized Digital Health Services

(75) Inventors: Ellen Prenelus, Boston, MA (US); Michael Joseph, Milton, VT (US); Douglas Spilling, Elizabethtown, NY (US); Mark Meisel, Haworth, NJ (US)

Correspondence Address: HANLEY, FLIGHT & ZIMMERMAN, LLC, 150 S. WACKER DRIVE, SUITE 2100, CHICAGO, IL, 60606, US

(73) Assignee: GENERAL ELECTRIC COMPANY, Schenectady, NY (US)

(21) Appl. No.: 12/240,719

(22) Filed: Sep. 29, 2008

(51) Int. Cl. G06Q 50/00

(52) U.S. Cl. 705/3

(57) ABSTRACT

Certain embodiments provide systems and methods for providing personalized, interconnected digital health services. Certain embodiments provide a digital health services system. The system includes an access portal providing access to health information for a patient from a plurality of clinical data sources. The system also includes a shared registry and repository storing information from the plurality of clinical data sources for interconnection and access via the access portal. The system further includes digital health information and services generating a personalized care plan for the patient based on health information from the shared registry and repository in conjunction with one or more rules applied to the health information to match the care plan with the health information for the patient and to track patient outcomes based upon compliance with the recommended care plan.

### RELATED APPLICATIONS

[Not Applicable]

### FEDERALLY SPONSORED RESEARCH OR DEVELOPMENT

[Not Applicable]

### [MICROFICHE/COPYRIGHT REFERENCE]

[Not Applicable]

### BACKGROUND OF THE INVENTION

The present invention generally relates to a interconnected healthcare information framework. More particularly, the present invention relates to providing personalized digital health services via an interconnected, standards-based healthcare information framework.

Hospitals typically utilize computer systems to manage the various departments within a hospital and data about each patient is collected by a variety of computer systems. A patient medical report is an example of the kind of report that could be sent to a data repository for public data mining. Medication instructions, such as documentation and/or prescription, as well as laboratory results and/or vital signs, may also be generated electronically and saved in a data repository.

As medical technology becomes more sophisticated, clinical analysis may also become more sophisticated. Increasing amounts of data are generated and archived electronically. With the advent of clinical information systems, a patient's history may be available at a touch of a button. While accessibility of information is advantageous, time is a scarce commodity in a clinical setting. To realize a full benefit of medical technological growth, it would be highly desirable for clinical information to be organized and standardized.

Even if clinical or image-related information is organized, current systems often organize data in a format determined by developers that is unusable by one or more medical practitioners in the field. Additionally, information may be stored in a format that does not lend itself to data retrieval and usage in other contexts. Thus, a need exists to structure data and instructions in a way that is easier to comprehend and utilize.

Efforts are underway nationally to connect healthcare information systems and make them interoperable in a secure, sustainable, and standards-based manner. However, the required information infrastructure is still under development, both for the National Health Information Network (NHIN) led by the federal government, as well as for the many small Regional Health Information Organizations (RHIOs) across the nation. Many challenges remain for health information exchange in the United States and elsewhere. For example, financial sustainability models must be determined for construction and operation of NHINs and RHIOs. Additionally, there is a need for standardization and interoperability of healthcare information among participants in exchange networks. Furthermore, there is a need for systems providing centralization versus distributed data architectures.

In the current medical environment, access to patient medical records is cumbersome and fragmented. Typically, medical records are maintained at individual clinics. If a patient visits more than one clinic, a patient may have a plurality of medical records. For example, a patient may visit a first clinic and create a first medical record and the patient may subsequently visit a second clinic and create a second medical record. If the second clinic does not have access to the first medical record, the examination and diagnosis at the second clinic may be duplicative and inefficient.

The lack of comprehensive medical records is also duplicative and inefficient for the patient. For example, a patient typically fills out similar forms at each clinic the patient attends. The patient may fill out a form with the patient's medical history, various conditions, allergies, heredity information, or other information. The individual clinic then maintains their own record for the patient. As a patient may visit a plurality of clinics in his or her life, the patient may repeatedly fill out the same information. In some circumstances, the patient may not fill out the same information, and various medical records at different clinics may contain partial and/or out-of-date information.

In addition, the decentralized nature of patient medical record information is perpetuated by entities other than medical clinics. For example, medical record information may be maintained by insurance entities, pharmaceutical entities, and/or laboratory entities. An update of the patient medical record at any one of these entities does not ensure the other entities are updated. Accordingly, the patient medical record information differs depending on the entity. Accordingly, it is difficult to locate a medical record that is completely up-to-date, and a treating physician may not be able to obtain a complete picture of a patient's health prior to treatment.

Moreover, the decentralized nature of patient medical record information typically does not allow a patient to access his or her medical records. A patient cannot review a comprehensive report of his or her medical history and various conditions. The patient generally does not have the ability to access or update his or her medical records. In addition, the patient does not have the ability to restrict access to his or her medical records.

As a consequence of patient information being decentralized and a patient not having access to his or her patient medical record information, the information available to a patient regarding his or her health status is typically of a general nature. For example, a patient has limited sources of medical information. One of the sources from which a patient may attempt to gather information is the Internet. A patient may search for medical information on the Internet and find various web sites providing general information about a condition. Some of the information may be applicable to the context of the patient and some of the information may not. A patient may have difficulty in reviewing the available information and determining what information is applicable to his or her circumstances.

### BRIEF SUMMARY OF THE INVENTION

Certain embodiments provide systems and methods for providing personalized, interconnected digital health services.

Certain embodiments provide a digital health services system. The system includes an access portal providing access to health information for a patient from a plurality of clinical data sources. The system also includes a shared registry and repository storing information from the plurality of clinical data sources for interconnection and access via the access portal. The system further includes digital health information and services generating a personalized care plan for the patient based on health information from the shared registry and repository in conjunction with one or more rules applied to the health information to match the care plan with the health information for the patient and to track patient outcomes based upon compliance with the recommended care plan.

Certain embodiments provide a method for managing health information. The method includes facilitating access to health information for a patient via an electronic access portal. The method also includes exchanging health information across a plurality of health data sources with respect to the patient via a cross-enterprise document sharing registry and repository. The method further includes generating a recommended care plan personalized for the patient based on health information from the registry and repository based on one or more rules for matching the care plan with the health information for the patient. Additionally, the method includes tracking patient outcomes based upon compliance with the recommended care plan.

Certain embodiments provide a digital health services connectivity framework. The framework includes a data layer including one or more repositories, registries, and records for clinical data. The framework also includes a services layer including one or more services processing clinical data from the data layer to provide clinical services to a user. The framework further includes a user integration layer facilitating access to information and services by the user in the services layer and the data layer. Additionally, the framework includes a connectivity layer facilitating transfer of data from one or more clinical sources to one or more of the data layer and services layer.

### BRIEF DESCRIPTION OF SEVERAL VIEWS OF THE DRAWINGS

FIG. 1 illustrates a health information technology infrastructure in accordance with certain embodiments of the present invention.

FIG. 2 shows a relationship and exchange of information in a healthcare network in accordance with certain embodiments of the present invention.

FIG. 3 shows a connectivity framework of architectural layers enabling product and information interoperability using a standards-based approach in accordance with certain embodiments of the present invention.

FIG. 4 illustrates a health information architecture in accordance with certain embodiments of the present invention.

FIG. 5 illustrates a health information architecture in accordance with certain embodiments of the present invention.

FIG. 6 illustrates a flow diagram for a method for managing health information and services in accordance with certain embodiments of the present invention.

The foregoing summary, as well as the following detailed description of certain embodiments of the present invention, will be better understood when read in conjunction with the appended drawings. For the purpose of illustrating the invention, certain embodiments are shown in the drawings. It should be understood, however, that the present invention is not limited to the arrangements and instrumentality shown in the attached drawings.

### DETAILED DESCRIPTION OF THE INVENTION

Certain embodiments above may be applied to an architecture and components based upon Health Information Exchange (HIE) standards, such as document storage, querying, connectivity to data sources, data registry/repository, population-based clinical quality improvement and research database with reporting tools, hosted interfaces, master patient registry, master provider registry, etc. Combining cross-enterprise document sharing (XDS) with a clinical data repository (CDR) enables the original content and context of the documents to be preserved but also enables capture of clinically relevant values to enable other uses of the data beyond limitations of the document. Such combination may include normalization of data across data sources, for example. Certain embodiments also facilitate data access and information exchange across multiple data sources, such as payers, financial institutions, EMR systems, practice management systems, claims/prescription databases, pharmaceutical companies, physician/hospital portals, pharmacy benefit management (PBM), etc. Further, certain embodiments provide rules based pushing/pulling of information to/from a patient, members of the patient's care team (professional and family), other third parties and specific devices based on profile of each data source. Information can include secure messaging and images and/or scanned clinical documents, for example. Rules can include manual or automatic data exchange, request and acceptance of types of data, etc.

Certain embodiments provide Web portal applications for data presentation to patients. A Web-based portal can provide an adaptive and proactive experience for users including matching technology/tools, education/information, and guided feedback based upon a patient's specific personality and lifestyle assessment, for example.

Certain embodiments apply artificial intelligence to compliance tools to form a personalized care plan combined with customized algorithms based on a broad but targeted data set (e.g., patient entered data, EMR data, other third party clinical and financial/administrative data, etc.) to provide tracking of a care management plan, text and graphical projected simulations of an impact to a patient based upon the patient's choices (e.g., your blood pressure will be x vs. y if you do A, B, and C), etc. Projected simulations can include financial as well as medical scenarios, for example.

Certain embodiments incorporate non-healthcare specific technologies, such as Sametime/synchronous eVisit collaboration tools, social interaction/community sites, tools to help manage healthcare choices (e.g., financial calculators, quality assessment tools, etc.), and the like.

Certain embodiments facilitate tracking of patient outcomes versus compliance via Medical Quality Improvement Consortium (MQIC) and other infrastructure tools, for example. Certain embodiments provide an extension of the tools/information exchange architecture for physician specific portal services.

Certain embodiments provide systems and methods with an ability to aggregate a patient's health information across multiple sources of data (e.g., a physician's electronic medical record, clinic or hospital electronic medical record, payer claims history, pharmaceutical chronic disease management, financial institutions/accounts, etc.) and do so using clinical healthcare information exchange (HIE) standards, for example. Certain embodiments provide systems connected to a patient's medical record(s) in an interactive way, wherein records automatically adapt to the patient's preferences to achieve the most likely compliance level and/or keep up with changing health conditions of the patient, for example.

Additionally certain embodiments help address the complex problem of facilitating patient comprehension and decision making by providing standards based organizational tools that automatically adapt to the specific and changing health conditions of the patient and provide comprehensive education and compliance tools to drive positive health outcomes.

Standards-based components are utilized for information exchange. These components can conform to the latest healthcare industry technical standards. In situations where clinical systems that will be sending patient information to participating registries and repositories cannot communicate according to one or more industry standards, messages can be transformed into messages complying with one or more applicable standards prior to being added to the registries or repositories.

Data can be aggregated across multiple data sources to give a patient a global view of his or her record. In prior systems, only a localized view of the patient's information was available via an EMR, insurance claims database, or payer sponsored portal.

In certain embodiments, registries and repositories are flexible enough to accommodate clinical, financial and demographic data about a patient. Registries and repositories can manage and maintain the data for the life of the patient. In prior systems, the data is no longer available to the patient when the patient is no longer being seen or is managed by another entity (e.g., clinic, payer, and employer). Additionally, a patient can add his or her own information to the registries and repositories. This allows the patient to save personal information about his or her health in a personal health record (PHR).

Certain embodiments allow the patient to communicate with providers of care by forwarding clinical documents to providers for referral work. Certain embodiments also enable review of patient created documents by the provider. Certain embodiments allow the patient to grant or deny access to their information to providers of care. This helps to give the patient more flexibility and better control over his or her record than patients had in prior systems.

Interconnection of multiple data sources helps enable an engagement of all relevant members of a patient's care team and helps improve an administrative and management burden on the patient for managing his or her care. Particularly, interconnecting the patient's electronic medical record and/or other medical data can help improve patient care and management of patient information. Furthermore, patient care compliance is facilitated by providing tools that automatically adapt to the specific and changing health conditions of the patient and provide comprehensive education and compliance tools to drive positive health outcomes.

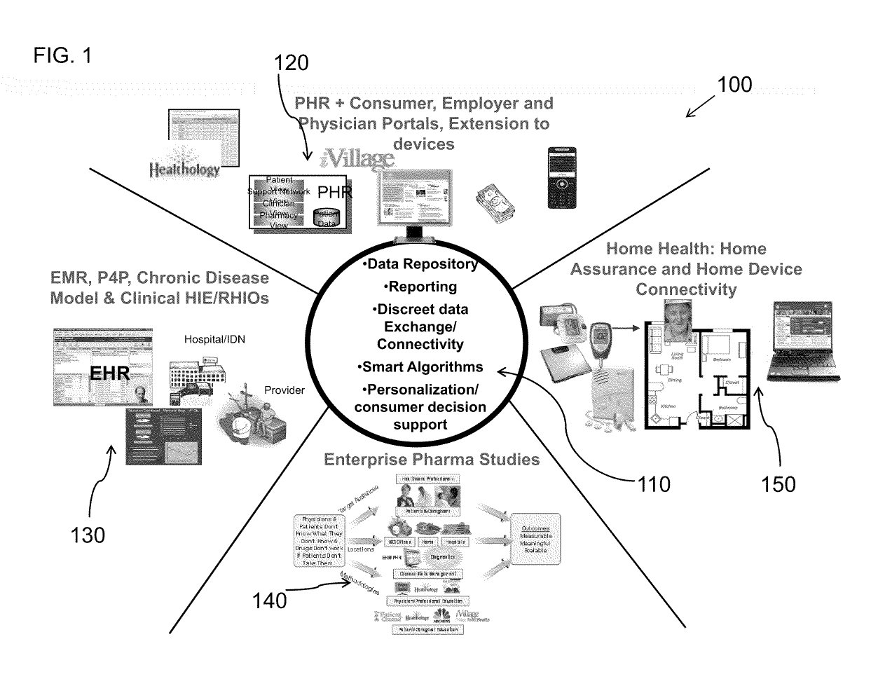

FIG. 1 illustrates a healthcare information technology (IT) infrastructure 100 that is adapted to service multiple business interests while providing clinical information and services in accordance with certain example embodiments. As shown in FIG. 1, a centralized capability 110 including, for example, a data repository, reporting, discreet data exchange/connectivity, “smart” algorithms, personalization/consumer decision support, etc. This centralized capability provides information and functionality to a plurality of users including 1) PHR, devices, and consumer, employer, and physician portals 120; 2) EMR, pay for performance (P4P), chronic disease models, and clinical HIE/RHIOs 130; 3) enterprise pharmaceutical studies 140; and/or 4) home health including home assurance and home device connectivity 150, for example.

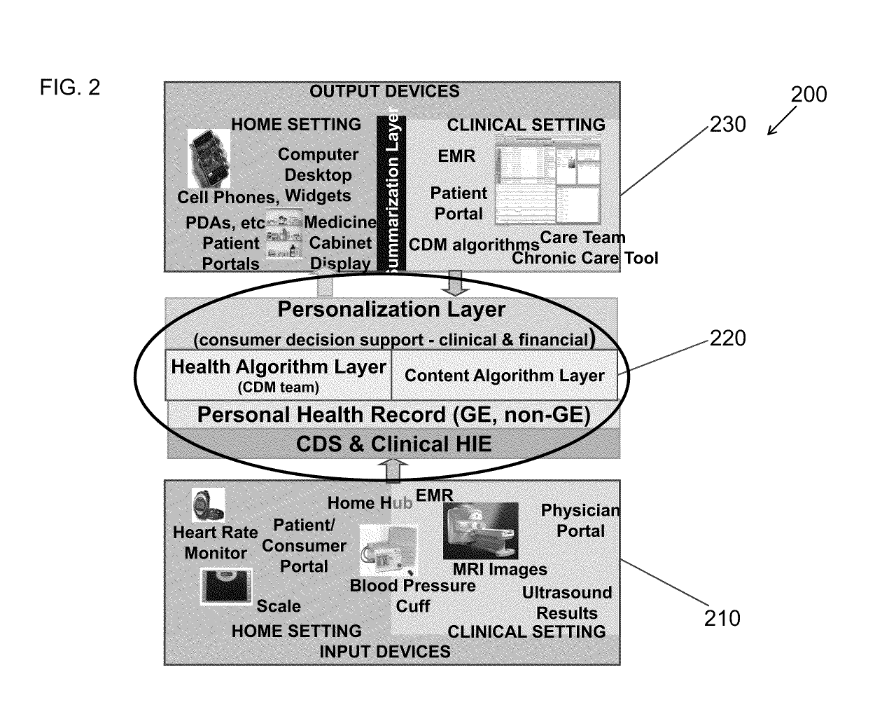

An example, depicted in FIG. 2, shows a relationship and exchange of information in a healthcare network 200 between input devices 210, healthcare information and services 220, and output devices 230. The input devices 210 include a set of devices that a patient may use to record various health parameters. The output devices 230 include a set of devices that can display content to users (e.g., consumers/patients, caregivers, etc.) in a personalized or customized manner. Healthcare information and services 220 includes clinical decision support and clinical HIE support, personal health record information, one or more algorithm layers (e.g., a health algorithm layer, a content algorithm layer, etc.), and a personalization layer (e.g., clinical and financial consumer decision support), for example.

Healthcare information and services 220 can provide normalization, repository, analytics, and exchange of clinical data from the input devices 210 into the PHR at both a document level and a discreet level, for example. Healthcare information and services 220 can provide health-related data stored in a PHR structure automatically uploaded via clinical HIE capabilities as well as entered by the patient, for example. Healthcare information and services 220 can provide algorithms receiving data from the PHR, reasoning based on personalized algorithms, and making both health-related conclusions and content-related display decisions to send to the personalization layer, for example. In the personalization layer, healthcare information and services 220 tailor patient motivation, reminders, health status, and/or alerts for display. In addition, feedback from devices can be used to continuously refine patient messages/content and tool interaction, for example.

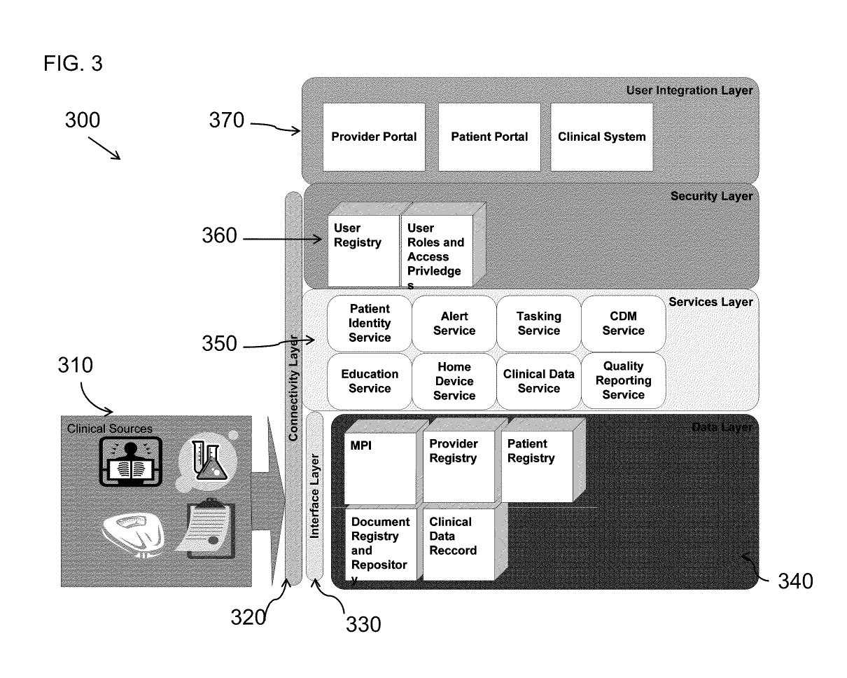

FIG. 3 shows a connectivity framework 300 of architectural layers enabling product and information interoperability using a standards-based approach in accordance with certain example embodiments. The connectivity framework 300 includes a plurality of clinical sources 310, a connectivity layer 320, an interface layer 330, a data layer 340, a services layer 350, a security layer 360, and a user integration layer 370, for example. The clinical sources 310 provide data for storage, processing, and/or other transmission through the layers of the framework 300. The connectivity layer 320 facilitates transfer of data from the clinical sources 310 to the data, services, and security layers 340, 350, 360 according to one or more standards/formats. The interface layer 330 provides additional interface capability for storage of data from clinical sources 310 in the data layer 340.

The data layer 340 includes one or more repositories, registries, and/or records for clinical data. For example, the data layer 340 can include an MPI, a provider registry, a patient registry, a clinical data record, and a document registry and repository.

The services layer 350 includes one or more services processing clinical data from the clinical sources 310, the data layer 340, and/or the user integration layer 370 via the security layer 350, for example. For example, the services layer 350 can include a patient identity service, an alert service, a tasking service, a CDM service, an education service, a home device service, a clinical data service, and/or a quality reporting service.

The security layer 360 helps to authenticate/regulate access, privileges, and updating of information via the clinical sources 310 and/or the user integration layer 370, for example. For example, the security layer 360 can include a user registry and/or user roles and access privileges.

The user integration layer 370 facilitates access by a variety of end users to information and services included in the services layer 350 and the data layer 340. For example, the user integration layer 370 can include a provider portal, a patient portal, and/or a clinical system.

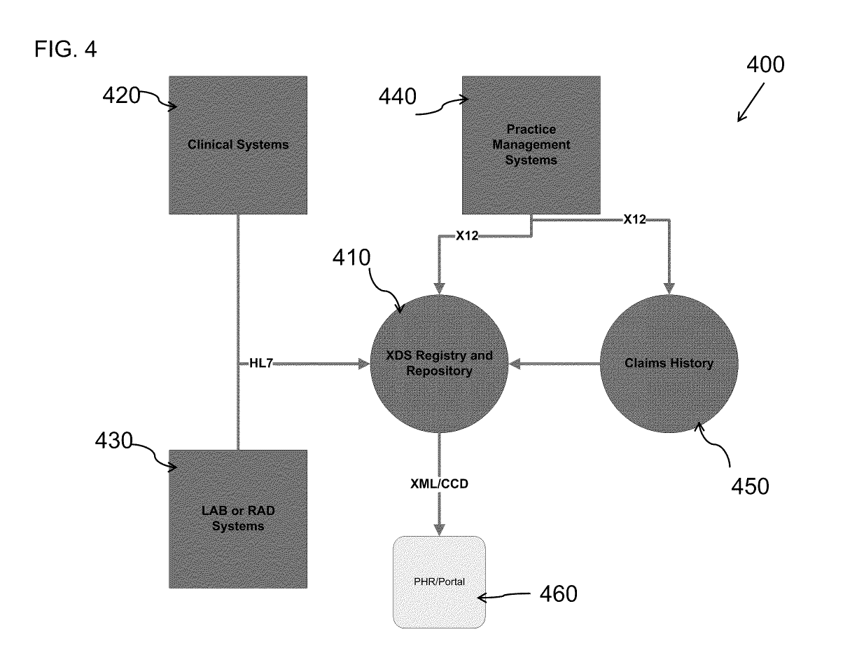

The framework 300 and layers of FIG. 3 can be implemented in conjunction with an example healthcare information exchange (HIE) 400 shown in FIG. 4. The HIE 400 is organized to provide storage, access and searchability of healthcare information across a plurality of organizations. The HIE 400 may service a community, a region, a nation, a group of related healthcare institutions, etc. For example, the HIE 400 may be implemented as and/or implemented with a regional health information organization (RHIO), national health information network (NHIN), medical quality improvement consortium (MQIC), etc. In certain embodiments, the HIE 400 connects healthcare information systems, practice management systems, and clinical systems, and helps make them interoperable in a secure, sustainable, and standards-based manner.

The HIE 400 provides a capability to exchange information between both related and disparate healthcare information systems. The HIE 400 helps facilitate access to and retrieval of clinical and other healthcare data with improved safety, timeliness and/or efficiency, etc. Components and/or participants in the HIE 400 adhere to a common set of principles and standards for information sharing within a provided technical infrastructure, for example. The HIE 400 may be used to store, access and/or retrieve a variety of data, including data related to outpatient and/or inpatient visits, laboratory results data, emergency department visit data, medications, allergies, pathology results data, enrollment and/or eligibility data, disease and/or chronic care management data/services, etc.

In certain embodiments, the HIE 400 provides a centralized data architecture. However, in certain embodiments, the HIE 400 may also utilize a combined centralized yet partially distributed data architecture. Certain embodiments create an aggregated, patient-centric view of health information. In certain embodiments, the HIE 400 provides one or more large databases of de-identified population data for quality improvement, care management, research, etc. Through the HIE 400, a patient and/or provider may control information access, privacy, and security, for example.

The HIE 400 includes an XDS repository and registry 410, one or more clinical systems 420, one or more lab or radiology systems 430, one or more practice systems 440, claims history 450, and a personal health record (PHR) portal 460. Systems 420, 430, 440 may include a variety of informational and/or query sources, such as healthcare facilities, labs, electronic medical record (EMR) systems, healthcare information systems, insurance systems, pharmaceutical systems, etc. A lab system may include information regarding tests performed on a patient and the results of the tests, for example. A clinical information system may include various types of clinical information regarding a patient, for example. A pharmaceutical system may include information regarding the prescriptions or drugs a patient may be using, for example. Claims history 450 may include records of insurers, for example. The PHR portal 460 may include one or more web viewers or portals, EMR systems, application service provider (ASP) systems, healthcare information systems, practice management systems, etc. Sources 420-460 are examples and other sources may be used. The components of the HIE 400 may be implemented individually and/or in various combinations in software, hardware and/or firmware, for example.

In certain embodiments, the HIE 400 provides a technical architecture, web applications, a data repository including EMR capability and a population-based clinical quality reporting system, for example. The architecture includes components for document storage, querying, and connectivity, such as the XDS registry and repository 410 and claims history 450. The portal 460 may include web portal applications for data presentation to physicians and patients, for example. In certain embodiments, the XDS registry and repository 410 may include an option for a subscription-based EMR for physicians, for example. In certain embodiments, the HIE 400 provides a population-based clinical quality improvement and research database with reporting tools, for example.

In certain embodiments, the XDS registry and repository 410 is a database or other data store adapted to store patient medical record data and associated audit logs in encrypted form, accessible to a patient as well as authorized medical clinics. In an embodiment, the XDS registry and repository 410 can be implemented as a server or a group of servers. The XDS registry and repository 410 can also be one server or group of servers that is connected to other servers or groups of servers at separate physical locations. The XDS registry and repository 410 can represent single units, separate units, or groups of units in separate forms and may be implemented in hardware and/or in software. The XDS registry and repository 410 can receive medical information from a plurality of sources.

Using an XDS standard, for example, in the HIE 400, document querying and storage can be integrated for more efficient and uniform information exchange. Using the HIE 400, quality reporting and research may be integrated in and/or with an RHIO and/or other environment. The HIE 400 can provide a single-vendor integrated system that can integrate and adapt to other standards-based systems, for example.

In certain embodiments, the HIE 400 helps to facilitate the implementation of an MQIC. Via the HIE 400, a group of EMR users may agree to pool data at the XDS registry and repository 410. The HIE 400 may then provide the group with access to aggregated data for research, best practices for patient diagnosis and treatment, quality improvement tools, etc. Through the MQIC and the HIE 400, users may help to improve the quality of healthcare through updated tools and expanded EMR quality improvement reports, for example. The MQIC and the HIE 400 offer members updated clinical information regarding patient illnesses, such as diabetes, heart attack, stroke, hypertension, congestive heart failure, and the like. Data exchange may also be used for clinical research. In certain embodiments, user may opt in or out of particular projects/collaborations via the HIE 400. In certain embodiments, a secure Internet line and/or Web-based portal may be used to access the HIE 400 to participate in a MQIC.

XDS provides registration, distribution, and access across healthcare enterprises to clinical documents forming a patient EMR. XDS provides support for storage, indexing, and query/retrieval of patient documents via a scalable architecture. Prior XDS registries and repositories were defined under IHE to support only one affinity domain, defined as a group of healthcare enterprise systems that have agreed upon policies to share their medical content with each other via a common set of policies and a single registry. Certain embodiments, however, support multiple affinity domains such that each affinity domain retains its autonomy as a separate affinity domain but shares one instance of hardware and software with the other involved affinity domains. The XDS registry and repository 410 can maintain an affinity domain relationship table used to describe clinical systems participating in each affinity domain. Once a request for a document is made, the source of the request is known and is used to determine which document(s) in the repository 410 are exposed to the requesting user, thus maintaining the autonomy of the affinity domain.

In certain embodiments, the XDS registry and repository 410 represents a central database for storing encrypted update-transactions for patient medical records, including usage history. In an embodiment, the XDS registry and repository 410 also stores patient medical records. The XDS registry and repository 410 stores and controls access to encrypted information. In an embodiment, medical records can be stored without using logic structures specific to medical records. In such a manner the XDS registry and repository 410 is not searchable. For example, a patient's data can be encrypted with a unique patient-owned key at the source of the data. The data is then uploaded to the XDS registry and repository 410. The patient's data may be downloaded to, for example, a computer unit and decrypted locally with the encryption key. In an embodiment, accessing software, for example software used by the patient and software used by the medical clinic performs the encryption/decryption.

In certain embodiments, the XDS registry and repository 410 maintains a registration of patients and a registration of medical clinics. Medical clinics may be registered in the XDS registry and repository 410 with name, address, and other identifying information. The medical clinics are issued an electronic key that is associated with a certificate. The medical clinics are also granted a security category. The security category is typically based on clinic type. In certain embodiments, the requests and data sent from medical clinics are digitally signed with the clinic's certificate and authenticated by the XDS registry and repository 410. Patients may be registered in the XDS registry and repository 410 with a patient identifier and password hash. Patients may also be registered in the XDS registry and repository 410 with name, address, and other identifying information. Typically, registered patients are issued a token containing a unique patient identifier and encryption key. The token may be, for example, a magnetic card, a fob card, or some other equipment that may be used to identify the patient. A patient may access the XDS registry and repository 410 utilizing their token, and in an embodiment, a user identifier and password.

In certain embodiments, the XDS registry and repository 410 can include program code, such as code implementing an acquisition algorithm, for acquiring data. The acquisition algorithm can acquire data regarding a patient from one or more sources, for example. The acquisition algorithm can acquire information from any of the sources 420-460, for example. The information acquired can be used to update a patient's medical record at the XDS registry and repository 410. In certain embodiments, the XDS registry and repository 410 also includes program code to perform a normalization algorithm. The normalization algorithm can process the information acquired by the acquisition algorithm and normalize the format. In certain embodiments, XDS registry and repository 410 can normalize the data acquired from the sources 420-460 into a standard format. The normalized data is stored in the patient's medical record with the XDS registry and repository 410, for example. Alternatively or in addition, one or more of the sources 420-460 can send data to the XDS registry and repository 410 once data is acquired. One or more of the sources 420-460 may have the patient register at the source of the data, for example. One or more of the sources 420-460 may then encrypt the data using the patient identifier and patient encryption key and send the data to the XDS registry and repository 410 to update the patient's medical record. Also, the data may be normalized by the sources 420-460 prior to sending to the XDS registry and repository 410.

In certain embodiments, the portal 460 and/or other system 420-450 can include a computer with a reader, such as a magnetic card reader that processes data when a magnetic card (e.g., a card with a magnetic strip) is passed through and/or in front of a receptacle. Alternatively or in addition, the reader can receive communication from other types of devices, such as for example a fob card, universal serial bus flash memory, or other type of memory equipment and/or software, for example.

In certain embodiments, the XDS registry and repository 410 can include and/or be in communication with an algorithm unit. The algorithm unit includes computer hardware and/or software for acquiring patient medical record information, processing the patient medical record information, and generating output for review by a user. The output of the algorithm unit includes a recommended care plan for the patient. The recommended care plan is based on the data available in the patient's medical record. In certain embodiments, a recommend care plan algorithm receives data from a patient's medical record and processes the data. Based on the data available, the recommended care plan algorithm outputs a recommended care plan for the patient.

For example, the XDS registry and repository 410 may acquire information from a plurality of sources such as 420, 430, and 440. The XDS registry and repository 410 can normalize the acquired data to a standard format. The algorithm unit may receive as input data that is stored at the XDS registry and repository 410 for a patient. The data stored at the XDS registry and repository 410 can be a compilation of data from various sources, such as from payers, financial institutions, electronic medical records, practice management systems, claims databases, pharmaceutical companies, laboratories, physicians, hospitals, and/or other sources. The recommended care algorithm may identify, among other things, the patient's conditions and degree of severity of the conditions. The recommended care algorithm may also consider data such as sex, age, height, weight, heredity, lifestyle factors, activity level, and/or other factors. The recommended care algorithm may utilize these factors and provide a recommended care plan. The recommended care plan may include techniques for improved health based on the patient's condition. For example, the recommended care plan may include an exercise plan with identifiable goals, such as the goal of walking a certain distance three times a week. A patient may then report back to computer software whether the goals have been achieved. In an embodiment, the patient's report is uploaded to the XDS registry and repository 410 and become part of the patient's medical records.

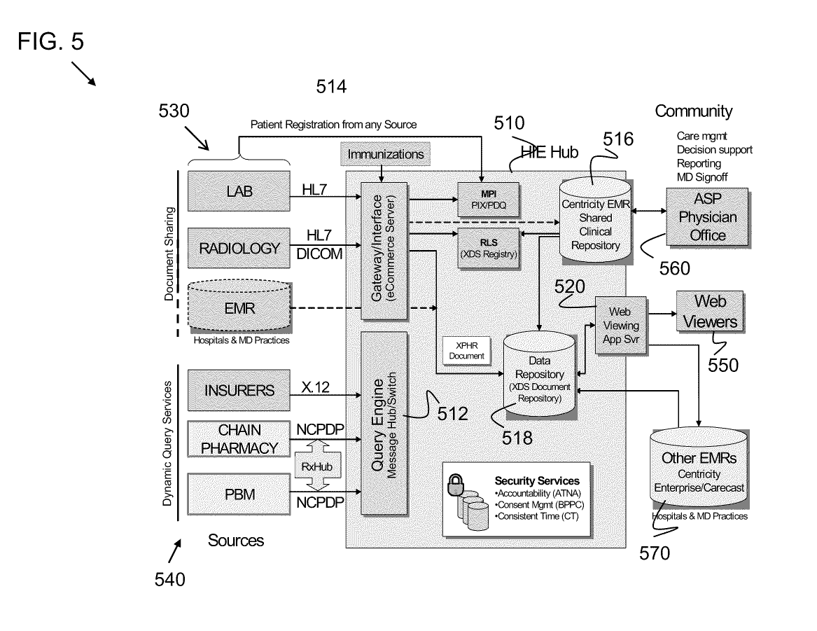

FIG. 5 illustrates a health information architecture 500 in accordance with an embodiment of the present invention. The architecture 500 includes an HIE hub 510, one or more data sharing sources 530, one or more data query sources 540, one or more Web viewers 550, a physician office application service provider (ASP) 560 and one or more EMRs 570. The HIE hub 510 may include a plurality of subcomponents, such as a query engine 512, a gateway or interface 514, an EMR shared clinical repository 516, a data repository 518 and a Web viewing application server 520. The hub 510 may also provide security services for the storage, retrieval and query of data, for example. Data source(s) 530 may include EMR, radiology, laboratory and/or other clinical data sources, for example. Data query source(s) 540 may include insurers, pharmacies, prescription benefit managers, and/or other services, for example. The components of the health information architecture 500 may be implemented individually and/or in various combinations in software, hardware and/or firmware, for example.

In operation, document sharing may be facilitated by the architecture 500 via the hub 510. Patient data is passed from one or more sources 520 using an interface standard, such as the standards approved by the Health Information Technology Standards Panel (HITSP) and accepted by the US Department of Health and Human Services (HHS), Health Level Seven (HL7) and/or Digital Imaging and Communications in Medicine (DICOM) communication interface and file format standards. Data enters the hub 510 via the gateway/interface 514. Within the hub 510, a message passing interface (MPI), including a patient identifier cross-reference (PIX) and/or a patient demographic query (PDQ) may help facilitate exchanging of relevant patient data. Furthermore, a record locator service (RLS) may be used in the hub 510 to help locate appropriate shared documents using a cross-enterprise document sharing (XDS) registry, for example. Clinical data and/or documents may be stored in the EMR shared clinical repository 516 and/or the data repository 518.

One or more query sources 540 may transmit query information to the query engine 512 using an interface standard, such as the X.12 and/or National Council for Prescription Drug Programs (NCPDP) communication standard or standards approved by HITSP and accepted by HHS. The query engine 512 serves as a message hub and/or switch to route query messages to appropriate repository(ies).

In certain embodiments, the data repository 518 includes an XDS document repository populated at least in part by Continuity of Care Documents (CCD) or other clinical summary documents from the Electronic Medical Record (EMR), from any source 530 or 540, or by personal health record (PHR) documents. These documents can be forwarded to users 560 and/or 570, or queried by them. For example, the data repository 518 may include exchanging personal health record (XPHR) content providing common information requested by healthcare providers. Through XPHR, patients may provide a summary of their PHR information to providers, and providers may suggest updates to a patient's PHR after a healthcare encounter.

A community of one or more physician or other healthcare office systems may store, access, or exchange information in the EMR shared clinical repository 516, such as an ASP-based office system 560. For example, information relating to care management, decision support, reporting and/or physician signoff may be utilized. Alternatively and/or in addition, data from the data repository 518 may be exchanged with one or more EMRs 570 (e.g., primary care provider EMRs), for example. Data from the data repository 518 may also and/or alternatively be provided to one or more Web viewers or portals 550 via a Web server or application 520.

In certain embodiments, a Web portal may be used to facilitate access to information, patient care and/or practice management, for example. Information and/or functionality available via the Web portal may include one or more of order entry, laboratory test results review system, patient information, clinical decision support, medication management, scheduling, electronic mail and/or messaging, medical resources, etc.

In certain embodiments, the Web portal serves as a central interface to access information and applications, for example. Data may be viewed through the Web-based portal or viewer, for example. Additionally, data may be manipulated and propagated using the Web portal, for example. Data may be generated, modified, stored and/or used and then communicated to another application or system to be modified, stored and/or used, for example, via the Web portal and HIE hub.

The Web portal may be accessible locally (e.g., in an office) and/or remotely (e.g., via the Internet and/or other private network or connection), for example. The Web portal may be configured to help or guide a user in accessing data and/or functions to facilitate patient care and practice management, for example. In certain embodiments, the Web portal may be configured according to certain rules, preferences and/or functions, for example. For example, a user may customize the Web portal according to particular desires, preferences and/or requirements.

In certain embodiments, an XDS profile and/or protocol (e.g., an Integrating the Healthcare Enterprise Cross-Enterprise Sharing of Medical Summaries Integration Profile (IHE XDS-MS) protocol) may be used to define a coupling or connection between one or more entities for patient document sharing. For example, XDS may be used to form a query identifying sources with information about a particular patient and/or other criteria, determining an identifier used to associate clinical data related to the patient and/or other criteria and request patient information from the appropriate source and/or repository, such as an XDS document repository 518, for example. As discussed above, a record locator service (RLS) may also be used to facilitate sharing of information between organizations.

In certain embodiments, the hub 510 provides security services during transmission and querying of data. Security services may include generation and storage of audit records, such as audit trail and node authentication (ATNA) accountability records. Additionally, security services may include patient privacy consent management, such as basic patient privacy consent (BPPC). Security services may also include coordination or consistency of time (CT) across network systems.

In certain embodiments, the architecture 500 supports trusted intermediaries or actors within the hub 510 to associate identity and trust among data/service providers and data/service clients. Once a source and/or user have been authenticated, the hub 510 can use the authentication to establish a security context for the data. Patient privacy consent, such as BPPC may provide a profile for access control to data and/or systems, for example. Patient consent is obtained from a patient and establishes rules for sharing and using patient data. Patient privacy consent may combine with authentication, for example, to help ensure reliability and security in the architecture 500. For example, cross-user authentication and patient consent may be used to authenticate sharing of EMR information for a patient between two healthcare entities. A BPPC profile may provide an implementation of privacy consent policies in the architecture 500, and a language or protocol, such as Extensible Access Control Markup Language (XACML), may be used with the BPPC to implement access control rules.

Using one or more of the systems described above, an end-to-end digital health services and platform can be provided to help enable a personalized, adaptive, and more comprehensive patient medical record that is connected with the patient's physicians/care team, payers, employers, and financial institutions. Medical records can be aggregated and connected via an XDS registry and repository and shared by multiple sources/users of data as well as services. For example, information from a physician's electronic medical record for a patient, a clinic or hospital electronic medical record, payer claims history, pharmaceutical chronic disease management, and/or financial institutions/accounts can be interactively aggregated using clinical HIE standards. Such interconnection helps personal health records automatically adapt to a patient's preferences to achieve a most likely compliance level and/or keep up with changing health conditions of a patient, for example. Additionally, patient comprehension and decision making can be facilitated by providing standards-based organizational tools that automatically adapt to the specific and changing health conditions of the patient and provide more comprehensive educational and compliance tools to help drive positive health outcomes.

Certain embodiments enable documentation and measurement of improvement across multiple therapeutic and wellness areas. Certain embodiments provide delivery and quality of recommended care along with patient compliance and outcomes management. For example, using an enterprise model as described above, adoption of disease state protocols for a variety of target audiences, locations, and methodologies leads to measurable, meaningful, and scalable outcomes. Via an access portal, such as a Web-based access portal, a user, such as a patient, clinician, or payer, can access information and educational services at a point of care and/or outside a visit as well as generate measured outcomes.

Certain embodiments provide clinician-directed intervention with a patient through an EMR platform including incorporating treatment and disease management guidelines into an EMR, providing professional education and training such as general disease overview and patient case-based information, and offering customized patient education electronically via the EMR, for example. Outcomes can be measured and managed via the EMR/MQIC and access portal in an enterprise model, for example.

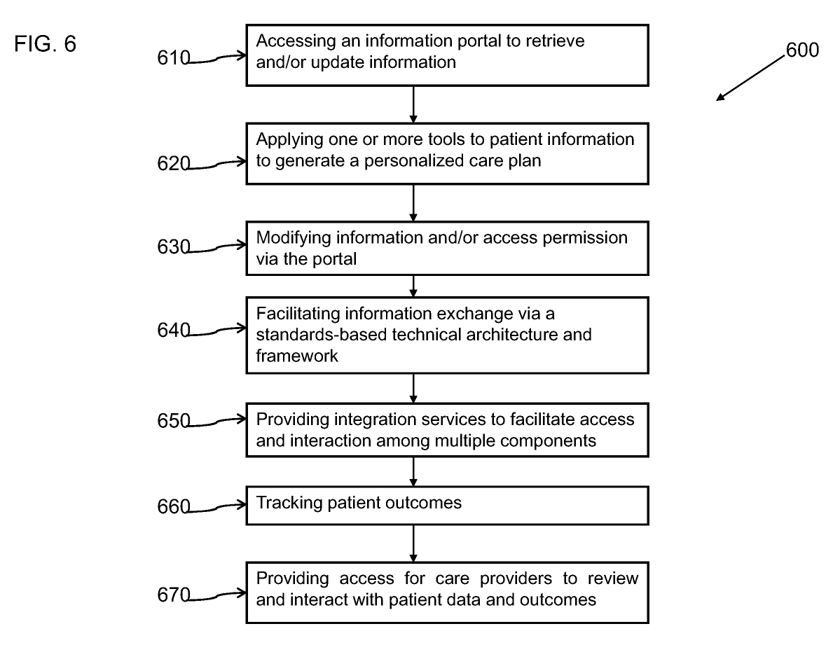

FIG. 6 illustrates a flow diagram for a method 600 for managing health information and services in accordance with an embodiment of the present invention. The method 600 illustrates a method executed, for example, when a patient logs into a website and/or other portal 460 and accesses the XDS registry and repository 410. The website can present the patient with an option of receiving health information in context of the patient's medical information, for example. For example, algorithm functionality associated with the XDS registry and repository 410 can execute computer software that processes the medical information available in the XDS registry and repository 410 for a medical patient and returns information about the conditions of the patient to the patient via the Web portal.

At 610, a patient accesses an information portal, such as a Web portal, to retrieve and/or update information. For example, the patient enters a patient identifier and password at an Internet website. The patient identifier and password grant the patient access to a set of tools. For example, via the portal, a patient can provide information for a personality and lifestyle assessment and receive technology/tools, educational information, and guided feedback matched to the patient assessment. In certain embodiments, the portal can be used to help facilitate patient comprehension and decision making by providing standards-based organizational tools that automatically adapt to the specific and changing health conditions of the patient and provide comprehensive education and compliance tools to drive positive health outcomes. In certain embodiments, the portal and associated resources provide a combination of a technical architecture, one or more Web applications, and a data repository to facilitate patient care.

At 620, one or more tools including one or more algorithms can be applied to patient information to generate a personalized care plan for the patient. For example, the patient can select a tool, such as an algorithms tool, to process his or her medical information. For example, artificial intelligence, such as artificial neural networks, fuzzy logic, Bayesian networks, etc., can be applied to compliance tools to provide personalized care plans combined with customized algorithms based on a broad but targeted data set (e.g., patient entered data, EMR data, other third party clinical and financial/administrative data, etc.) to provide tracking of care management plan, text and graphical projected simulations of the impact to the patient based upon his or her choices (e.g., the patient's blood pressure will be x rather than y if the patient does A, B, and C.). Projected simulations can include financial as well as medical scenarios, for example. In certain embodiments, non-healthcare specific technologies, such as collaboration/meeting software (e.g., Sametime, Webex, synchronous eVisit, etc.), social interaction/community websites (e.g., myspace for healthcare), tools to help manage healthcare choices (e.g., financial calculators, quality assessment tools, etc.), and the like can be provided to the patient via the portal.

At 630, the patient can modify information and/or access permission via the portal. For example, the portal can provide an ability for the patient to change his or her demographic information. The portal can provide an ability for the patient to grant PHR access to providers, care givers, spouse and children, for example. The portal can provide an ability for the patient to view clinical information from those clinical sites that are participating in the sharing of health information, for example. In certain embodiments, the patient can select the clinical source(s) that the patient deems reliable. In certain embodiments, the patient can enter Problems, Medications, and/or Allergies via the portal that may not be in the clinical source system(s). In certain embodiments, the patient can run an audit report that shows who has viewed the patient's PHR information and when the information was viewed, for example.

In certain embodiments, patient data can be decrypted and loaded into an XDS registry and repository. In certain embodiments, the patient can download his or her medical information from the XDS registry and repository to his or her computer. The patient can then decrypt the medical information at the local computer and upload medical information back to algorithm(s) of the XDS registry and repository. Alternatively, the patient can authorize the XDS registry and repository to access and process patient data already stored, such as through use of an encryption key for the patient, for example. The patient can upload the encryption key and allow the XDS registry and repository and/or associated hardware/software to decrypt the patient data. Alternatively or in addition, computer software can be executed on the patient's computer. Accordingly, the patient can download the medical record from the XDS registry and repository, decrypt the medical record on the patient's computer, and execute one or more algorithms on the patient's computer.

In certain embodiments, a patient can establish a care management plan via the portal resources. The patient can enter data into his or her PHR to show conformance to the care management plan, for example. Proactive tools can be provided to generate guided feedback based upon the patient's specific personality and lifestyle assessment, for example. Artificial intelligence tools can be applied to help the patient understand how he or she is doing against the care management plan. In certain embodiments, one or more reports can be provided that describe projected simulations of the impact to the patient based upon his or her choices (for example, the patient's blood pressure will be x rather than y if a series of conditions A, B, and C occur). In certain embodiments, the projected simulations can include financial as well as medical scenarios, for example.

In certain embodiments, the portal provides a patient with communication tools such as instant messaging and/or email to facilitate communication between the patient and other members of the health community. The portal can provide an ability to schedule a visit with the patient's provider if the clinical source system can support such a request. The portal can provide an ability to request a medication refill with the patient's provider if the clinical source system can support such a request. Further, the portal can provide an ability for the patient to save his or her PHR information to portable media such as a CD, DVD, or USB drive. In certain embodiments, a patient can save a scanned document to his or her PHR, for example.

In certain embodiments, based on the context of a problem the patient is experiencing, the portal and its connected resources can be used to provide helpful medical information from other internet sources. This information can be used to better educate the patient on his or her particular problem or diagnosis, for example.

At 640, information exchange is facilitated using a technical architecture and framework based upon clinical standards, such as IHE standards. For example, document storage, querying, connectivity to data sources, data registry/repository, population-based clinical quality improvement and research database with reporting tools, hosted interfaces, master patient registry, master provider registry, document and data storage using MQIC, etc. are provided according to IHE standards. Certain embodiments combine XDS with CDR such that the original content and context of the documents can be preserved but an accompanying CDR database is available to capture clinically relevant values to enable other uses of the data beyond the limitations of the document itself. Certain embodiments can include normalization of data across data sources mapped to standards. Data access and information exchange are provided across multiple data sources: payers, financial institutions, EMR systems, practice management systems, claims databases, pharmaceutical companies, physician/hospital portals, PBMs, eRxing clearinghouses, and the like. Rules based pushing/pulling of information to/from the patient, members of their care team (professional and family), other third parties, and specific devices are provided based on profile for each data source, including sharing of text/secure messaging and images/scanned clinical documents, for example. Rules may include manual or automatic data exchange, request and acceptance of types of data, etc.

At 650, integration services are provided to facilitate access and interaction among multiple components. For example, integration services are provided to convert messages from clinical source systems to a standard message. User setup and authentication services are provided to configure a new user, authenticate the new users, and restrict the user to the appropriate areas of the web portal, for example. Such services can support an ability for the patient to grant access to his or her PHR to other users as well as audit who accessed the clinical data and when the data was accessed.

Clinical data can be stored in XDS repositories complying with IHE standards, for example. A patient can build a PHR using one or more local identifiers from clinical sources. The local identifiers can be mapped from the clinical sources to a global patient identifier, for example. Patient data can be managed and maintained for the life of the patient. The XDS registry/repository can provide support for a variety of profiles including an XDS-MS (medical summary) profile, an XDS-Lab (laboratory) profile, an XDS-I (medical imaging) profile, an XDS-SD (scanned document) profile, an XDS-XM (external media) profile, etc. In certain embodiments, a security model is provided to support a patient's ability to grant/deny access for other users to see and/or update the patient's PHR (e.g., for referrals, providers of care, spouses, children, etc.).

At 660, patient outcomes are tracked. For example, clinical data can be anonymized and aggregated by one or more criteria including disease, geographic region, provider, provider group, patient demographics, and state to allow end users (e.g., patients, providers, payers, pharmaceuticals, etc.) to view the clinical data for comparison purposes. For example, normal value ranges can be tracked for common diseases. These values can be used to show normal/abnormal results when reviewing aggregated clinical data, for example. Additionally, reports can be generated and provided to care providers to show how their patients with a particular disease compare to a population of patients with the same or a similar disease, for example. Comparison reports can be provided with respect to specific diseases to show how a patient is doing for a particular disease state against a larger population of patient with the same or similar disease, for example.

Further, automated reminders can be provided for patients that have a care management plan. For example, when pre-established milestones are scheduled in the care management plan, a reminder can be sent to the patient regarding the impending milestone (e.g., a foot check, eye check, stress test, etc.). Automated alerts can be provided for patients that display abnormal results. The alerts can be sent directly to the patient's primary care physician, for example.

Using data from patient outcome reports, the patient can be automatically directed to resources that can help the patient bring his or her abnormal values back in line with the norms. Also, resources reviewed by the patient can be tracked and the patient's care management plan updated with these events.

At 670, access is provided for care providers to review and interact with patient data and outcomes. For example, physician-specific portal services can be provided. A portal can provide an ability for providers of care to review their patients' information and status, for example. Providers of care can review a particular patient's PHR, for example. Providers of care can send messages to patients via the portal, for example. Care providers can also respond to questions submitted by patients, for example. Further, care providers can import data from a patient's PHR into the provider's EMR system via the portal, for example. In certain embodiments, providers can access and review alerts created by patients that display abnormal results due to recent clinical activity. In certain embodiments, the portal access provides an ability to run reports that measure a provider's quality of providing care to particular population(s) of patients and can also compare scores to national averages and/or measures, for example. Certain embodiments provide access to educational resources made available by entities such as Healthology.

In operation, for example, a patient that has recently been diagnosed with diabetes may receive information from the treating physician. The physician may log the diagnosis and treatment specifics in the patient's electronic medical record. In addition, various tests and laboratory information may be recorded as part of the patient's electronic medical record, or may be recorded separately. Similarly, the pharmaceutical information may be recorded as part of the patent's electronic medical record or may be recorded separately. In an embodiment, the medical information is acquired by or sent to the XDS registry and repository 410. In an embodiment, the medical information is normalized by the sources of the information prior to sending to the XDS registry and repository 410 or the medical information is normalized by the XDS registry and repository 410 prior to storing as part of the medical record.

A patient may log into an Internet website and enter the patient identifier and password at an Internet website. The patient may select the option to receive a recommended care plan. In an embodiment, the medical information of the patient is decrypted and processed by the XDS registry and repository 410. For example, hardware and/or software associated with the XDS registry and repository 410 can process the information with the recommended care plan algorithm. The recommended care plan algorithm can return a result that is specific to the context of the patient. In an embodiment, a recommended care plan is returned based on the outputs of the recommended care plan algorithm. In an embodiment, the recommended care plan is emailed to the patient for review and may be periodically updated with reminders.

More particularly, for example, a recommend care plan algorithm receives data from the patient's medical record and processes the data. Based on the data available, the recommended care plan algorithm outputs a recommended care plan for the patient. The recommended care plan algorithm can identify, among other things, the patient's conditions and degree of severity of the conditions. The recommended care algorithm can also consider data such as sex, age, height, weight, heredity, lifestyle factors, activity level, and/or other factors. The recommended care plan algorithm can utilize these factors and provide a recommended care plan. The recommended care plan can include techniques for improved health based on the patient's condition. For example, the recommended care plan can include diet recommendations to an individual that has been diagnosed with diabetes.

A care plan can be recommended based on the results of the recommended care plan algorithm. The recommended care plan can include, for example, techniques for improved health based on the patient's condition. For example, the recommended care plan can include diet recommendations to an individual that has been diagnosed with diabetes. The recommended care plan is typically customized to the patient and provides recommendations and information based on the specific health of the patient as opposed to generalized information. Alternatively or in addition, sponsored information, such as educational material, product/service offerings, advertisements, etc., can be output to the patient instead of or in addition to care plan information.

Thus, certain embodiments provide information exchange across multiple data sources using clinical HIE standards. Certain embodiments provide connectivity and information exchange with a PHR/Portal across multiple data sources (e.g., payers, financial institutions, EMR systems, practice management systems, claims databases, pharmaceutical companies, physician/hospital portals, PBMs, eRxing clearinghouses, etc.) and/or mobile devices. Certain embodiments provide rules based access/sharing of text/secure messaging and images/scanned clinical documents. Rules can include manual or automatic data exchange, request and acceptance of types of data, etc.

Certain embodiments provide adaptive and proactive systems and methods to match technology/tools, education/information, and guided feedback with a patient's specific personality and lifestyle. For example, a level of coaching, information presented, and type of tools are based upon clinical/medical data combined with patient self assessed personality profile (e.g., a morbidly obese individual would start with 5 minutes of walking and not 45 minutes of walking). Certain embodiments match an appropriate care plan with the patient based upon the EMR, care plan data, and evidence based guidelines.

Certain embodiments provide “smart” tools applying artificial intelligence technology to patient compliance tools such as customized algorithms based on a broad but targeted data set to provide tracking of care management plan, text and graphical projected simulations of the impact to the patient based upon the patient's choices.

Certain embodiments provide outcome-driven systems and methods for tracking of clinical and financial outcomes based upon compliance (e.g., improved health, health milestones, reduced encounters per patient, reduced expensive procedures, etc.). Certain embodiments provide tracking capabilities using MQIC, Centricity EDI Services, and the like.

Certain embodiments provide an extension of a tools/information exchange architecture for physician specific portal services. Certain embodiments facilitate provider, care delivery organization (CDO), chronic disease management team access to patient data, and personalized interaction with patients outside of a visit.

Certain embodiments help to meet consumer online healthcare needs by providing online content, experts, tools, and community to help patients and their families make healthcare decisions. Certain embodiments expand professional content to offer education materials and courses, multimedia content for viewing and/or download, and clinical intervention programs to improve patient outcomes, for example. Certain embodiments provide an EHR infrastructure including core tools and functionality to drive physician-patient interactions, education, compliance, and improved healthcare. Certain embodiments provide a digital health services platform including broadcast capability, a consumer health portal, an employee health or payor portal, a physician/provider portal, chronic disease and/or coordinated care management tools, and a PHR technology and data infrastructure, for example.

Several embodiments are described above with reference to drawings. These drawings illustrate certain details of specific embodiments that implement the systems and methods and programs of the present invention. However, describing the invention with drawings should not be construed as imposing on the invention any limitations associated with features shown in the drawings. The present invention contemplates methods, systems and program products on any machine-readable media for accomplishing its operations. As noted above, the embodiments of the present invention may be implemented using an existing computer processor, or by a special purpose computer processor incorporated for this or another purpose or by a hardwired system.

As noted above, embodiments within the scope of the present invention include program products comprising machine-readable media for carrying or having machine-executable instructions or data structures stored thereon. Such machine-readable media can be any available media that can be accessed by a general purpose or special purpose computer or other machine with a processor. By way of example, such machine-readable media may comprise RAM, ROM, PROM, EPROM, EEPROM, Flash, CD-ROM or other optical disk storage, magnetic disk storage or other magnetic storage devices, or any other medium which can be used to carry or store desired program code in the form of machine-executable instructions or data structures and which can be accessed by a general purpose or special purpose computer or other machine with a processor. When information is transferred or provided over a network or another communications connection (either hardwired, wireless, or a combination of hardwired or wireless) to a machine, the machine properly views the connection as a machine-readable medium. Thus, any such a connection is properly termed a machine-readable medium. Combinations of the above are also included within the scope of machine-readable media. Machine-executable instructions comprise, for example, instructions and data which cause a general purpose computer, special purpose computer, or special purpose processing machines to perform a certain function or group of functions.

Embodiments of the invention are described in the general context of method steps which may be implemented in one embodiment by a program product including machine-executable instructions, such as program code, for example in the form of program modules executed by machines in networked environments. Generally, program modules include routines, programs, objects, components, data structures, etc., that perform particular tasks or implement particular abstract data types. Machine-executable instructions, associated data structures, and program modules represent examples of program code for executing steps of the methods disclosed herein. The particular sequence of such executable instructions or associated data structures represents examples of corresponding acts for implementing the functions described in such steps.

Embodiments of the present invention may be practiced in a networked environment using logical connections to one or more remote computers having processors. Logical connections may include a local area network (LAN) and a wide area network (WAN) that are presented here by way of example and not limitation. Such networking environments are commonplace in office-wide or enterprise-wide computer networks, intranets and the Internet and may use a wide variety of different communication protocols. Those skilled in the art will appreciate that such network computing environments will typically encompass many types of computer system configurations, including personal computers, hand-held devices, multi-processor systems, microprocessor-based or programmable consumer electronics, network PCs, minicomputers, mainframe computers, and the like. Embodiments of the invention may also be practiced in distributed computing environments where tasks are performed by local and remote processing devices that are linked (either by hardwired links, wireless links, or by a combination of hardwired or wireless links) through a communications network. In a distributed computing environment, program modules may be located in both local and remote memory storage devices.

An exemplary system for implementing the overall system or portions of the invention might include a general purpose computing device in the form of a computer, including a processing unit, a system memory, and a system bus that couples various system components including the system memory to the processing unit. The system memory may include read only memory (ROM) and random access memory (RAM). The computer may also include a magnetic hard disk drive for reading from and writing to a magnetic hard disk, a magnetic disk drive for reading from or writing to a removable magnetic disk, and an optical disk drive for reading from or writing to a removable optical disk such as a CD ROM or other optical media. The drives and their associated machine-readable media provide nonvolatile storage of machine-executable instructions, data structures, program modules and other data for the computer.

While the invention has been described with reference to exemplary embodiments, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims. Moreover, the use of the terms first, second, etc. do not denote any order or importance, but rather the terms first, second, etc. are used to distinguish one element from another.

1. A digital health services system, said system comprising:
an access portal providing access to health information for a patient from a plurality of clinical data sources;
a shared registry and repository storing information from the plurality of clinical data sources for interconnection and access via the access portal; and
digital health information and services generating a personalized care plan for the patient based on health information from the shared registry and repository in conjunction with one or more rules applied to the health information to match the care plan with the health information for the patient and to track patient outcomes based upon compliance with the recommended care plan.

2. The system of claim 1, wherein the plurality of clinical data sources further comprises one or more of a payer, a financial institution, an electronic medical record, a practice management system, a claims database, a pharmaceutical system, a physician portal, and a laboratory system.

3. The system of claim 1, wherein the access portal provides access for the patient and wherein the system further comprises a clinical source interface facilitating exchange of information by the plurality of clinical data sources.

4. The system of claim 1, further comprising a provider portal providing healthcare provider access to patient health information and care plan compliance, the provider portal facilitating personalized interaction with the patient outside of an office visit.

5. The system of claim 1, wherein artificial intelligence and patient compliance tools are used to generate customized algorithms for tracking the recommended care plan for the patient and provide projected simulations of an impact to the patient based on patient action.

6. The system of claim 1, wherein the access portal, shared registry and repository, and digital health information and services provide a connectivity framework of a plurality of layers to enable product and information interoperability using one or more clinical standards.

7. A method for managing health information, said method comprising:
facilitating access to health information for a patient via an electronic access portal;
exchanging health information across a plurality of health data sources with respect to the patient via a cross-enterprise document sharing registry and repository;
generating a recommended care plan personalized for the patient based on health information from the registry and repository based on one or more rules for matching the care plan with the health information for the patient; and
tracking patient outcomes based upon compliance with the recommended care plan.

8. The method of claim 7, further comprising modifying at least one of health information for the patient and access permission for the health information for the patient via the electronic access portal.

9. The method of claim 7, further comprising facilitating review of the recommended care plan and patient compliance by a care provider.

10. The method of claim 7, wherein the plurality of health data sources further comprises one or more of a payer, a financial institution, an electronic medical record, a practice management system, a claims database, a pharmaceutical system, a physician portal, and a laboratory system.

11. The method of claim 7, further comprising providing healthcare provider access to patient health information and care plan compliance and facilitating personalized interaction with the patient outside of an office visit.

12. The method of claim 7, wherein generating a recommended care plan further comprises using artificial intelligence and patient compliance tools to generate customized algorithms for tracking the recommended care plan for the patient and provide projected simulations of an impact to the patient based on patient action.

13. The method of claim 7, further comprising providing a connectivity framework of a plurality of layers to enable product and information interoperability using one or more clinical standards.

14. A digital health services connectivity framework, said framework comprising:
a data layer including one or more repositories, registries, and records for clinical data;
a services layer including one or more services processing clinical data from the data layer to provide clinical services to a user;
a user integration layer facilitating access to information and services by the user in the services layer and the data layer; and
a connectivity layer facilitating transfer of data from one or more clinical sources to one or more of the data layer and services layer.

15. The framework of claim 14, further comprising a security layer authenticating the user and regulating access to the services layer and the data layer.

16. The framework of claim 14, further comprising an interface layer facilitating transfer and storage of data to and from the one or more clinical sources in conjunction with the connectivity layer.

17. The framework of claim 14, wherein the data layer further comprises a shared registry and repository storing information from the one or more clinical sources for interconnection and access via the services layer and the user integration layer.

18. The framework of claim 14, wherein the services layer further comprises a digital health information and services generating a personalized care plan for the patient based on clinical data from the data layer in conjunction with one or more rules applied to the clinical data.

19. The framework of claim 18, wherein the services layer allows the user track patient outcomes based upon compliance with the personalized care plan.

20. The framework of claim 18, wherein the services layer further comprises artificial intelligence and patient compliance tools to provide customized algorithms for tracking the recommended care plan for the patient and providing projected simulations of an impact to the patient based on patient action.
